(19) United States
(12) Patent Application Publication
(10) Pub. No.: US 2007/0115767 A1
(43) Pub. Date: May 24, 2007

(54) Optical pickup device

(75) Inventors: Kenji Nagatomi, Kaidu-City (JP); Seiji Kajiyama, Ibi-Gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/598,565

(22) Filed: Nov. 14, 2006

(30) Foreign Application Priority Data
Nov. 18, 2005 (JP) 2005-334708 (P)
Nov. 28, 2005 (JP) 2005-341551 (P)

(51) Int. Cl. G11B 7/00; G11B 7/135

(52) U.S. Cl. 369/44.23; 369/112.02

(57) ABSTRACT

A wavefront of a laser light is adjusted using a phase correcting element. The phase correcting element includes an electrode layer, an electrode layer arranged facing the former electrode layer, orientation films arranged on a surface facing the electrode layers, and a liquid crystal layer filled between the orientation films. One of the two electrode layers is formed with an electrode pattern (ring shaped electrode) for providing a spherical aberration correcting effect to the laser light within a constant distance from a center of a beam incident diameter, and a continuous electrode is arranged on an outer side thereof. Occurrence of the aberration by a lens shift is effectively suppressed by omitting electrodes arranged slightly on an inner side of the conventional beam incident diameter.

This application claims priority under 35 U.S.C. Section 119 of Japanese Patent Application No. 2005-334708 filed Nov. 18, 2005 and Japanese Patent Application No. 2005-341551 filed Nov. 28, 2005.

### BACKGROUND OF THE INVENTION

1. Field of the Invention

The present invention relates to optical pickup devices, and in particular, to an optical pickup device suited for use in suppressing spherical aberration.

2. Description of the Related Art

An objective lens of higher numerical aperture is recently being used with higher density of an optical disk. However, aberration tends to easily occur in a laser light due to error in substrate thickness etc. of the optical disk when such an objective lens of higher numerical aperture is used. In such a case, a spherical aberration correcting means thus becomes necessary in the optical pickup device.

Japanese Laid-Open Patent Publication No. 10-269611 (patent document 1) discloses use of a liquid crystal panel for a spherical aberration correcting element. Furthermore, Japanese Laid-Open Patent Publication No. 2000-40249 (patent document 2) and Japanese Laid-Open Patent Publication No. 10-289465 (patent document 3) disclose use of the liquid crystal panel for an astigmatism correcting element and a coma aberration correcting element.

According to the invention described in patent document 1, a wavefront state of the laser light is corrected so as to suppress the spherical aberration by a phase correcting effect of the liquid crystal panel. However, if optical axes are misaligned between the liquid crystal panel and the objective lens due to lens shift of the objective lens, attachment error etc., the aberration consequently occurs in the laser light. In this case, a configuration in which the liquid crystal panel is attached to an objective lens actuator to integrally displace the liquid crystal panel and the objective lens may be used so as to suppress the optical axes between the liquid crystal panel and the objective lens from being misaligned. However, the objective lens actuator becomes larger, and drive response or dynamic response of the objective lens is adversely affected. Furthermore, when attachment error of the liquid crystal panel with respect to the objective lens actuator occurs, the misalignment of the optical axes between the objective lens and the liquid crystal panel becomes fixed, and consequently, the aberration originating from the misalignment of the optical axes occurs on a steady basis irrespective of the shifted position of the objective lens.

### SUMMARY OF THE INVENTION

The present invention, in view of solving the above problem, aims to provide an optical pickup device capable of effectively suppressing aberration from occurring in a laser light when a lens shift and the like occur to an objective lens.

An optical pickup device according to one aspect of the present invention includes a laser light source; an objective lens for converging a laser light exited from the laser light source onto a recording medium; and a phase correcting element, interposed between the laser light source and the objective lens, for providing a spherical aberration correcting effect only to one part of the laser light within an effective diameter of the objective lens.

In this aspect, the phase correcting element may be configured to provide the spherical aberration correcting effect to the laser light within a range of a constant distance from the center of the effective diameter.

According to this aspect, the spherical aberration correcting effect is not provided to all the laser light within the range of the effective diameter, but the spherical aberration correcting effect is provided only to one part thereof. Thus, even if optical axes are misaligned between the spherical aberration correcting element and the objective lens, aberration caused therefrom can be suppressed. This advantage will be verified in more detail in the following embodiment.

Since the present invention does not provide the spherical aberration correcting effect to all the laser light within the range of the effective diameter, but provides the spherical aberration correcting effect only to one part thereof, a means for providing another optical effect may be arranged in a region not used in the spherical aberration correcting effect out of the range of the effective diameter. For example, a means for providing an astigmatism correcting effect may be arranged in the relevant region. Therefore, the correction of the spherical aberration and the correction of the astigmatism are simultaneously achieved with one phase correcting element. If the phase correcting element is configured using liquid crystals, the correcting effect for the spherical aberration and the correcting effect for the astigmatism are provided by simply adjusting the electrode pattern as appropriate. Thus, the configuration of the phase correcting element can be simplified.

When the phase correcting element is configured using the liquid crystals, the phase correcting element includes a first electrode; a second electrode arranged facing the first electrode; a first orientation film arranged on a surface facing the second electrode of the first electrode; a second orientation film arranged on a surface facing the first electrode of the second electrode; and a liquid crystal layer filled between the first orientation film and the second orientation film; wherein the first electrode has an electrode pattern for providing the spherical aberration correcting effect to the laser light within a constant distance from the center of the effective diameter.

### BRIEF DESCRIPTION OF THE DRAWINGS

The invention, together with the above and other objects and novel features thereof, may best be understood by reference to the following description of the embodiment together with the accompanying drawings in which:

FIG. 1 is a view showing an optical system of an optical pickup device according to one embodiment of the present invention;

FIGS. 2A and 2B are views showing configurations and electrode patterns of a phase correcting element according to the embodiment of the present invention;

FIGS. 3A and 3B are views showing configurations and electrode patterns of a phase correcting element according to the conventional art (comparative example);

FIGS. 4A and 4B are views showing verification results by the electrode pattern according to the conventional art (comparative example) and the electrode pattern according to the embodiment of the present invention;

FIGS. 5A and 5B are views showing variants of the electrode pattern according the embodiment of the present invention;

FIGS. 6A to 6D are views explaining an astigmatism correcting effect according to the embodiment of the present invention;

FIGS. 7A and 7B are views showing variants of the electrode pattern according to the embodiment of the present invention; and

FIGS. 8A and 8B are views showing further variants of the electrode pattern according to the embodiment of the present invention.

### DESCRIPTION OF PREFERRED EMBODIMENTS

The embodiments of the present invention will now be described. In the present embodiment the present invention applies to an optical pickup device used in a next generation DVD (Digital Versatile Disk) having a substrate thickness of 0.6 mm.

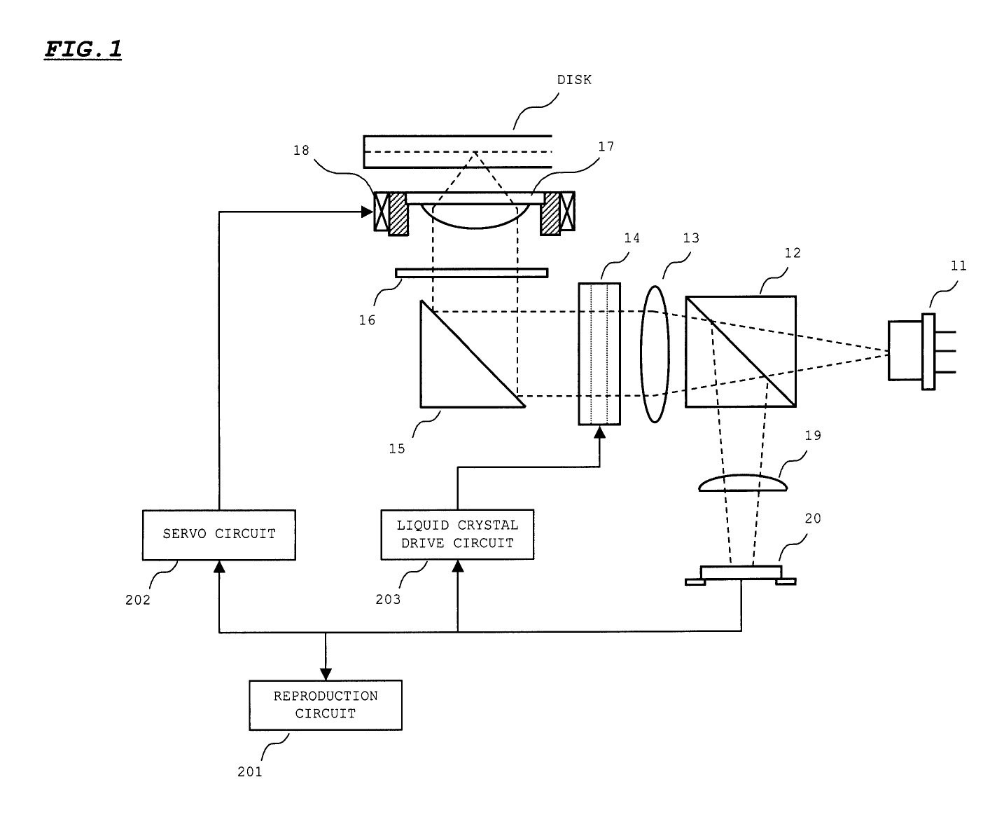

FIG. 1 shows an optical system of the optical pickup device according to the present embodiment. In the figure, a circuit configuration (reproduction circuit 201, servo circuit 202, and liquid crystal drive circuit 203) for drive controlling the optical pickup device is shown for the sake of convenience.

As shown in the figure, the optical pickup device includes a semiconductor laser 11, a polarizing beam splitter (polarizing BS) 12, a collimator lens 13, a phase correcting element 14, a mirror 15, a λ/4 plate 16, an objective lens 17, an objective lens actuator 18, a detection lens 19, and a light detector 20.

The semiconductor laser 11 exits the laser light of blue wavelength (407 nm in the present embodiment). The polarizing BS 12 transmits substantially all the laser light entered from the semiconductor lens 11, and substantially reflects all the laser light entered from the collimator lens 13. The collimator lens 13 converts the laser light from the polarizing BS 12 to parallel light. The phase correcting element 14 adjusts the wavefront state of the laser light from the collimator lens 13. The details of the phase correcting element 14 will be hereinafter described.

The mirror 15 raises the laser light from the phase correcting element 14 so as to be directed towards the objective lens 17. The λ/4 plate 16 converts the laser light from the mirror 15 to a circularly polarized light, and converts the laser light from the objective lens 17 to a linear polarized light that is orthogonal to the plane of polarization of the laser light from the mirror 15. The objective lens 17 converges the laser light from the λ/4 plate 16 onto the disk. The objective lens actuator 18 drives the objective lens 17 in the focus direction and in the tracking direction according to the drive signal from the servo circuit 202.

The detection lens 19 introduces astigmatism to the laser light from the polarizing BS 12 so as to allow the generation of a focus error signal based on the astigmatism method. The light detector 20 outputs a detection signal based on the laser light converged by the detection lens 19. A sensor pattern is provided to the light detector 20 to generate a reproduction RF signal, a tracking error signal and the focus error signal.

The reproduction circuit 201 generates the reproduction RF signal based on the detection signal input from the light detector 20 and further demodulates the reproduction RF signal to generate the reproduction data. The servo circuit 202 generates the tracking error signal and the focus error signal based on the detection signal input from the light detector 20, and further generates the tracking servo signal and the focus servo signal based on the tracking error signal and the focus error signal, and outputs the signals to the objective lens actuator 18. The liquid crystal drive circuit 203 generates a signal for driving the phase correcting element 14 based on the detection signal input from the light detector 20 and outputs the relevant signal to the phase correcting element 14. The liquid crystal driving circuit 203 generates the servo signal that converges the reproduction RF signal to a satisfactory state, and outputs the servo signal to the phase correcting element 14.

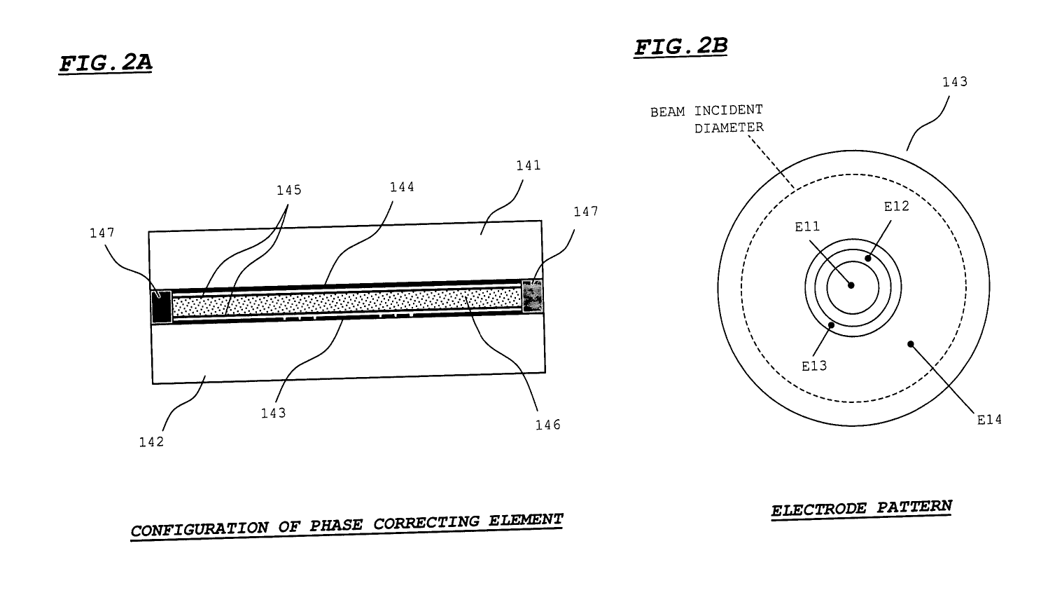

The configuration of the phase correcting element 14 will now be described with reference to FIGS. 2A and 2B.

FIG. 2A is a side cross sectional view in a case where the phase correcting element 14 is cut along the laser light transmitting direction. As shown in the figure, the phase correcting element 14 is configured by glass substrates 141 and 142; electrode layers 143 and 144; an orientation film 145; a liquid crystal layer 146; and a seal material 147.

The glass substrate 141 has a square plate shape of a constant thickness. The electrode layers 143 and 144 are made of an electrically conductive material allowing the transmission of the laser light, and the periphery thereof is circular. The orientation films 145, 145 are arranged on the side surfaces of the liquid crystal layer 146 of the electrode layers 143 and 144. The liquid crystal layer 146 is formed by filling the liquid crystals between the orientation films 145, 145. In the liquid crystal layer 146, the orientation direction of the liquid crystal molecules is changed by applying potential via the electrode layers 143 and 144. The seal material 147 is arranged to prevent leakage of the liquid crystals.

The electrode layer 144 has a uniform film shape continuous across the entire surface. The electrode layer 143 is formed with an electrode pattern as shown in FIG. 2B. In other words, a circular electrode El and three ring shaped electrodes E12, E13, E14 are arranged concentrically on the electrode layer 143.

When different potentials are applied to the electrodes E11 to E14 while maintaining a constant potential at the electrode layer 144 (e.g., earth potential), the orientation direction of the liquid crystal molecules between the electrodes E11 to E14 and the electrode layer 144 changes according to the applied potential. The index of refraction of the liquid crystal layer 146 thus changes at the position of the electrodes E11 to E14, and the phase of the laser light that passes the position of the electrodes E11 to E14 changes. As a result, the wavefront state of the laser light after passing the liquid crystal layer 146 changes according to the state of change in the relevant phase. Therefore, the wavefront state of the laser light can be adjusted by controlling the potential to be applied to the electrodes E11 to E14.

The electrode pattern according to the present embodiment has only two ring shaped electrodes E12 and E13 arranged on the inner circumferential part, and only one continuous uniform ring shaped electrode 14 arranged on the outer side thereof, as shown in FIG. 2B. Therefore, the laser light has a uniform phase according to the potential to be applied to the electrode E14 in the region between the inner side of the beam incident diameter (corresponds to effective diameter of objective lens 17) and the electrode E13.

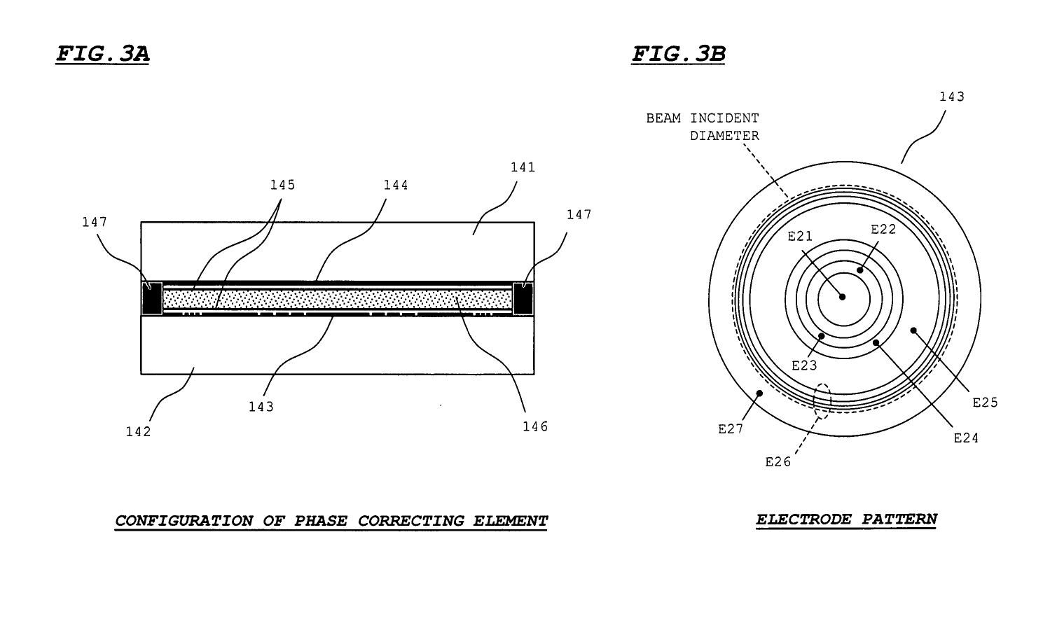

FIGS. 3A and 3B show the configuration example of the phase correcting element described in patent document 1. As shown in FIG. 3B, a circular electrode E21 and three ring shaped electrodes E22, E23, E24 are concentrically arranged on the inner circumferential side, and three ring shaped electrodes E26 are further arranged on a slightly inner side of the beam incident diameter on the electrode layer 143 of the phase correcting element. A ring shaped electrode E27 is further arranged on the outer side. Thus, the ring shaped electrode is also formed on the slightly inner side of the beam incident diameter in the phase correcting element described in patent document 1, different from the phase correcting element according to the present embodiment.

Verification

The inventors of the present invention compared and verified the occurrence state of the wavefront aberration at the beam converging position in a case where the phase correcting element of FIG. 2 according to the present embodiment is used and in a case where the phase correcting element of FIG. 3 according to the conventional art is used. The following description is based thereon.

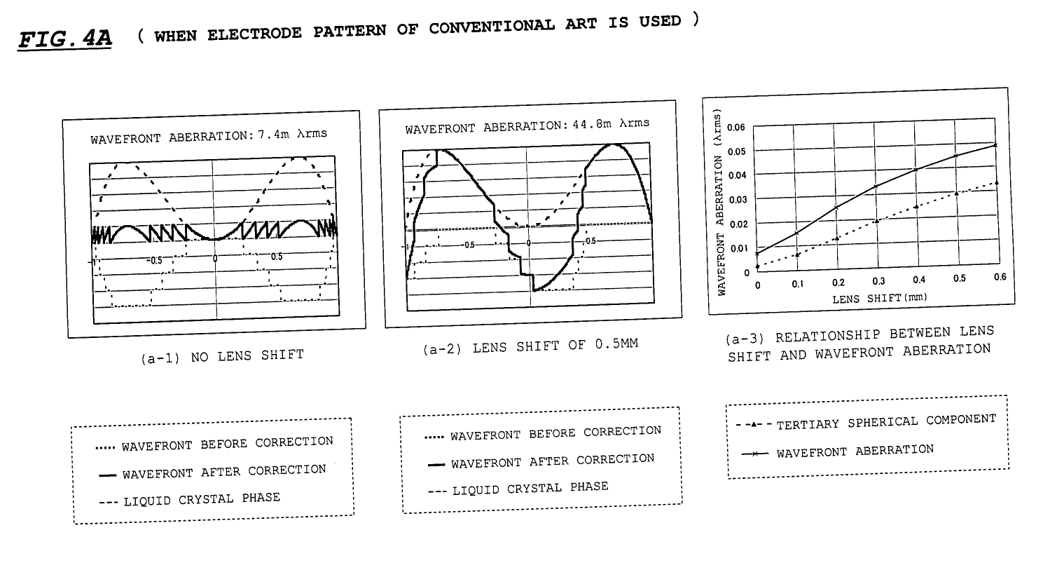

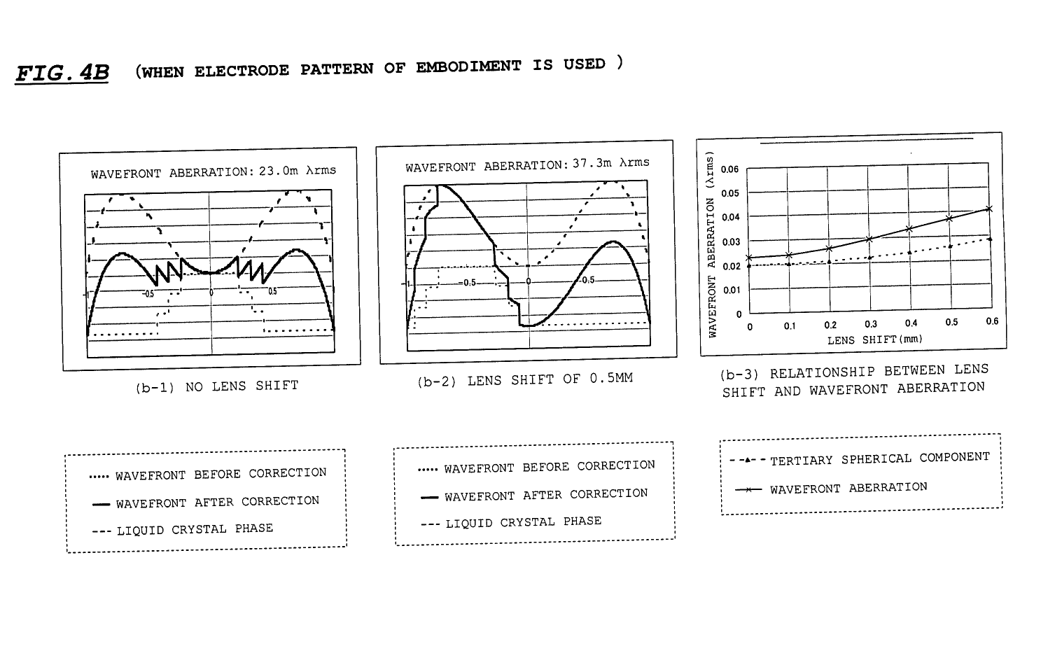

FIGS. 4A and 4B show the verification results (simulation). The conditions for the present verification are as follows.
Numerical aperture of objective lens: 0.65
Focal distance of objective lens: 2.3 mm
Substrate thickness of disk: 0.585 mm (error with respect to reference thickness=0.015 mm)
Wavelength of used laser: 407 nm

(a-1), (a-2), and (a-3) of FIG. 4A are simulation results (conventional example) when the pattern of the electrode layer 143 is configured as in FIG. 3B, and (b-1), (b-2), and (b-3) of FIG. 4B are simulation results (embodiment) when the pattern of the electrode layer 143 is configured as in FIG. 2B.

(a-1) of FIG. 4A and (b-1) of FIG. 4B show the relationship of the wavefront before correction (wavefront in a case where wavefront correction is not performed at the phase correcting element); the wavefront after correction (wavefront in a case where wavefront correction is performed at the phase correcting element); and the liquid crystal phase (distribution of phase introduced to the laser light by phase correcting element) with respect to when the misalignment (lens shift of the objective lens with respect to the optical axis of the phase correcting element) does not occur in the optical axes between the phase correcting element and the objective lens is not produced. (a-2) of FIG. 4A and (b-2) of FIG. 4B show the relationship of the wavefront before correction, the wavefront after correction, and the liquid crystal phase with respect to when misalignment (lens shift) of the optical axes occurs by 0.5 mm between the phase correcting element and the objective lens. In these figures, the horizontal axis indicates the distance in the radial direction from the optical axis of the objective lens when setting ½ of the effective diameter of the objective lens to 1, and the vertical axis indicates the distribution state of the wavefront and the phase in a standardized manner.

(a-3) of FIG. 4A and (b-3) of FIG. 4B are verification results showing the relationship between the amount of lens shift and the wavefront aberration. In addition to the total wavefront aberration (solid line), only the change in the tertiary spherical aberration is extracted and shown in (a-3) and (b-3).

In the verification, the potential that produces the liquid crystal phase shown in (a-1) of FIG. 4A and (b-1) of FIG. 4B is applied to the phase correcting element according to the conventional art and the phase correcting element according to the present embodiment via the electrodes E21 to E27 and the electrodes E11 to E14, respectively, of the electrode layer 143.

With reference to (a-1) of FIG. 4A and (b-1) of FIG. 4B, if misalignment of the optical axes (lens shift) does not occur at the objective lens, the wavefront state of the laser light is corrected over substantially the entire range when the phase correcting element according to the conventional art is used, whereas a relatively large change is seen on the wavefront state of the circumferential part of the beam diameter when the phase correcting element according to the embodiment is used. In this case, the wavefront aberration at the beam converging position is 7.4 mλrms when the phase correcting element according to the conventional art is used, and is 23.0 mλrms when the phase correcting element according to the embodiment is used. Therefore, the phase correcting element according to the conventional art excels in the aberration correcting ability when the lens shift is not produced.

When the misalignment of the optical axes (lens shift) of 0.5 mm occurs at the objective lens, the change in the wavefront state in the beam diameter direction becomes larger if the phase correcting element according to the conventional art is used than when the phase correcting element according to the embodiment is used, as shown in (a-2) of FIG. 4A and (b-2) of FIG. 4B. In this case, the wavefront aberration at the beam converging position drastically increases to 44.8 mλrms when the phase correcting element according to the conventional art is used, and is suppressed to 37.3 mλrms when the phase correcting element according to the embodiment is used. Therefore, the phase correcting element according to the embodiment excels in the aberration correcting ability when the lens shift is produced.

In comparing the aberration correcting ability of the phase correcting element according to the conventional art and the phase correcting element according to the embodiment with reference to (a-3) of FIG. 4A and (b-3) of FIG. 4B, with regards to the total wavefront aberration, the aberration correcting ability of both phase correcting elements is about the same extent when the amount of lens shift is about 0.2 mm, and the phase correcting element of the present embodiment exhibits a more superior aberration correcting ability when the amount of lens shift is larger. In particular, with regards to the tertiary spherical aberration component based on the substrate thickness error etc., the aberration correcting ability of both phase correcting elements is about the same extent if the amount of lens shift is a little over 0.15 mm, and the phase correcting element of the present embodiment exhibits a more superior correcting ability when the amount of lens shift is larger.

Therefore, the wavefront aberration produced in time of lens shift is more effectively suppressed according to the present embodiment compared to the conventional art. Furthermore, the number of electrode patterns of the electrode layer is reduced, and the configuration of the phase correcting element is simplified according to the present embodiment, as apparent from comparing and referencing FIGS. 2A and 2B, as well as FIGS. 3A and 3B.

In the above embodiment, the continuous electrode E14 is arranged on the outer side of the ring shaped electrode 13 as shown in FIGS. 2A and 2B, but an electrode for correcting other aberrations may be arranged in the relevant region.

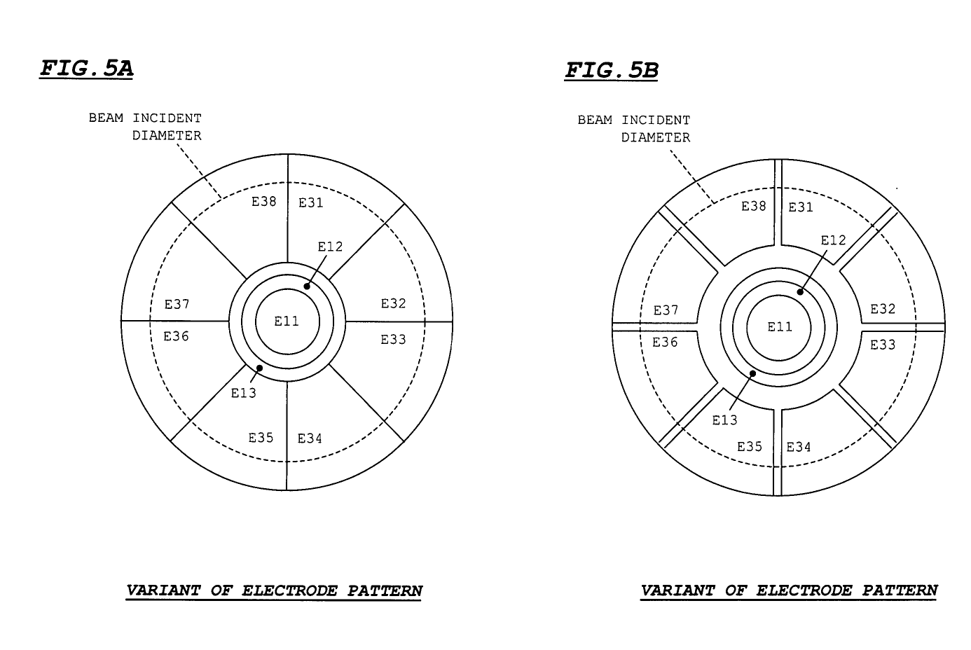

FIGS. 5A and 5B are configuration examples in a case where the astigmatism correction electrodes E31 to E38 are arranged on the outer side of the ring shaped electrode E13. The correcting effect for the spherical aberration is not affected even if the astigmatism correction electrodes E31 to E38 are arranged on the outer side of the ring shaped electrode E13 and the astigmatism correcting effect is simultaneously performed since the aberration function of astigmatism and the aberration function of the spherical aberration do not influence each other.

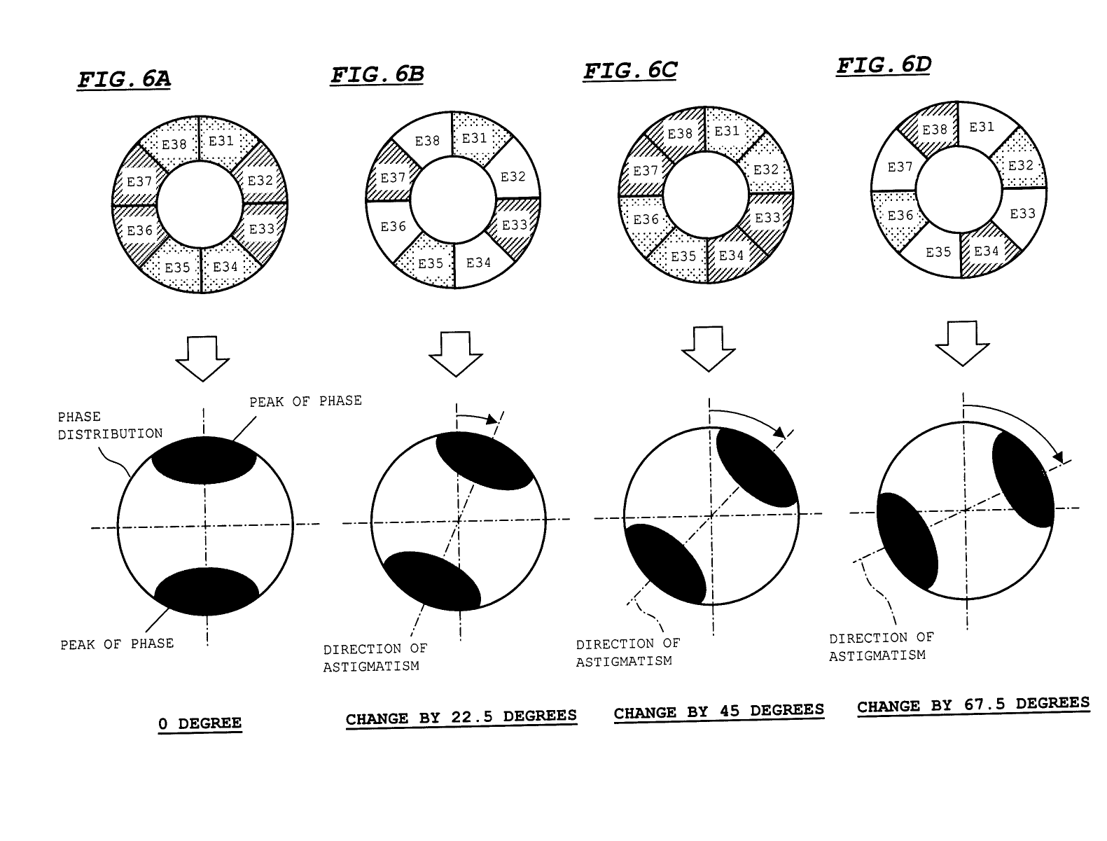

In time of correcting the astigmatism, the same potential is applied to the electrodes diametrically opposite each other out of the electrodes E31 to E38. For example, potential V1 is applied to the pair of E31 and E35 and to the pair of E34 and E38; and potential V2 different from the potential V1 is applied to the pair of E32 and E36 and to the pair of E33 and E37, as shown in the upper part of FIG. 6A. Thus, the phase distribution in which the peaks and valleys of the phase appear every 90 degrees in the beam circumferential direction can be produced at the phase correcting element, as shown in the lower part of FIG. 6A. As a result, the astigmatism correcting effect is introduced to the laser light passing through the phase correcting element.

As shown in FIGS. 6B, 6C, 6D, the direction of astigmatism in the beam circumferential direction can be changed by appropriately changing the electrodes to be applied with potential. If the electrodes are divided into eight segments in the circumferential direction as shown in FIGS. 5A and 5B, the direction of astigmatism can be changed by 22.5 degrees.

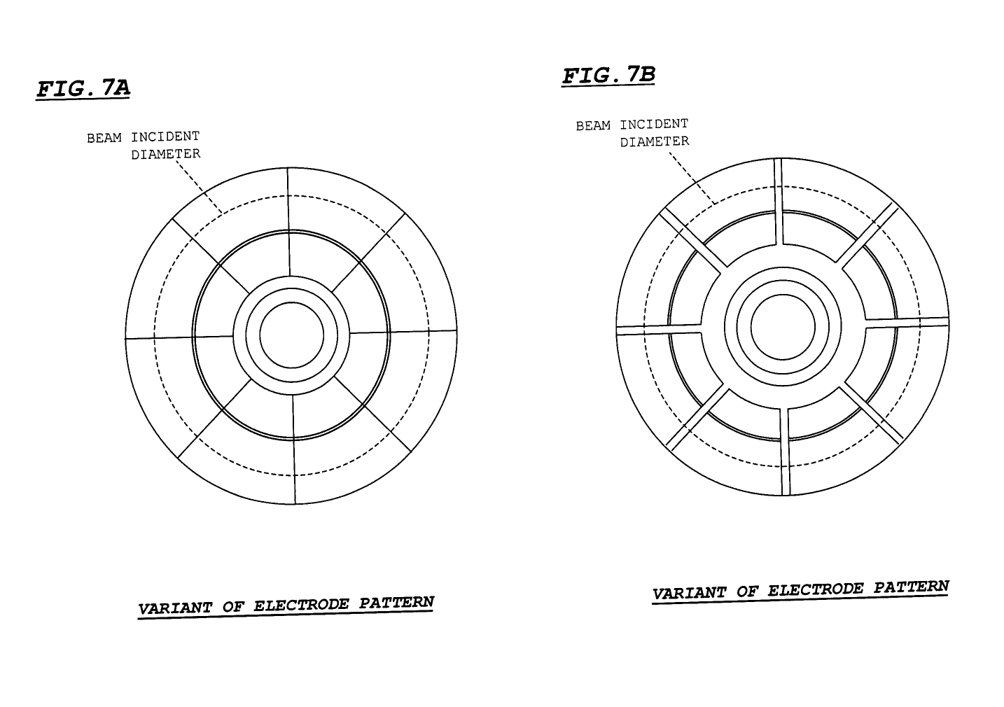

The astigmatism correcting electrode may be further divided into two in the radial direction, as shown in FIGS. 7A and 7B. In this case, the phase changes in the radial direction and a more precise introduction of the spherical aberration correcting effect and the astigmatism correcting effect can be performed.

In the above example, the electrode pattern for introducing the correcting effect for the spherical aberration or the astigmatism is arranged only on one of the electrode layers 143 out of the two electrode layers 143 and 144, but the electrode pattern for correcting other aberrations may be arranged on the other electrode layer 144.

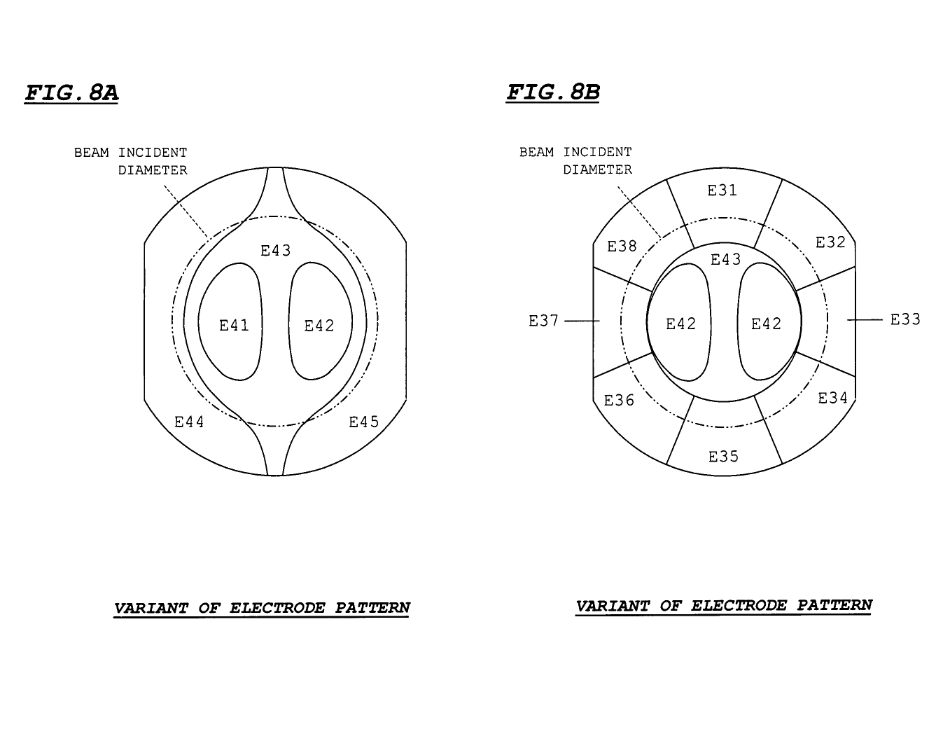

For example, the phase distribution for providing the coma aberration correcting effect can be provided to the phase correcting element by controlling the application potential of the electrodes E41 to E45 if the electrode pattern as shown in FIG. 8A is formed on the electrode layer 144. Since the aberration function of the coma aberration, and the aberration function of the astigmatism and the aberration function of the spherical aberration do not influence each other, the correcting effect for the spherical aberration and the correcting effect for the astigmatism are not influenced even if the coma aberration correcting electrodes E41 to E45 are arranged on the electrode layer 144 and the coma aberration correcting effect is simultaneously performed.

Furthermore, the electrode pattern of FIG. 2B may be applied as the electrode pattern of the electrode layer 143, and the electrode pattern in which the correcting effects of the astigmatism and the coma aberration can be simultaneously performed, as shown in FIG. 8B may be applied as the electrode pattern of the electrode layer 144. In this case, the astigmatism is corrected by controlling the application voltage to the electrodes E31 to E38, and the coma aberration is corrected by controlling the application voltage to the electrodes E41 to E43.

The embodiments of the present invention have been described, but the present invention is not limited thereto, and the embodiments may be modified in other various ways.

For example, an example of applying the present invention to the optical pickup device for next generation DVD has been described, in the above embodiment but the present invention may be applied to an optical pickup for DVD, and a compatible optical pickup device of the next generation DVD and the DVD. In the above embodiment, the phase correcting element 14 is arranged on the optical path from the semiconductor laser 11 to the objective lens 17 to correct the aberration on the optical disk, but a different aberration correcting element may be further arranged to correct the aberration on the light detector 20.

In the embodiment, the liquid crystal phase in the range on the outer side than about 0.5 mm in the objective lens shift direction from the center in the horizontal axis is made constant with reference to (b-1) of FIG. 4B, but the starting position at where the liquid crystal phase becomes constant is not limited thereto, and for example, the liquid crystal phase may be made constant from the position on the outer side than 0.5 mm from the center. In this case, the width or the number of levels of the ring shaped electrode on the inner circumferential part is appropriately adjusted.

Furthermore, again referring to (b-1) of FIG. 4B, the liquid crystal phase of the range on the outer side than about 0.5 mm in the objective lens shift direction from the center in the horizontal axis is made constant in the embodiment, but for example, the liquid crystal phase may be slightly raised in the range on the outer side from about 0.5 mm from the center, and then made constant from where the liquid crystal phase on the outer side is raised, and still obtain the effects substantially similar to the verification shown in FIG. 4B. In this case, the electrode for raising the liquid crystal phase is separately arranged.

In addition, various modifications may be appropriately made on the embodiment of the present invention within the scope of the technical concept described in the Claims.

It should be apparent to those skilled in the art that the present invention may be embodied in many other specific forms without departing from the spirit or scope of the invention. Therefore, the present invention is not to be limited to the details given herein, but may be modified within the scope and equivalence of the appended claims.

What is claimed is:

1. An optical pickup device comprising:
a laser light source;
an objective lens for converging a laser light exited from the laser light source onto a recording medium; and
a phase correcting element, interposed between the laser light source and the objective lens, for providing a spherical aberration correcting effect only to one part of the laser light within an effective diameter of the objective lens.

2. The optical pickup device according to claim 1, wherein the phase correcting element provides the spherical aberration correcting effect to the laser light within a range of a constant distance from a center of the effective diameter.

3. The optical pickup device according to claim 2, wherein the phase correcting element includes:
a first electrode;
a second electrode arranged facing the first electrode;
a first orientation film arranged on a surface facing the second electrode of the first electrode;
a second orientation film arranged on a surface facing the first electrode of the second electrode; and
a liquid crystal layer filled between the first orientation film and the second orientation film; wherein
the first electrode has an electrode pattern for providing the spherical aberration correcting effect to the laser light within the constant distance from the center of the effective diameter.

4. The optical pickup device according to claim 2, wherein the phase correcting element introduces an optical effect other than the correcting effect for the spherical aberration to the laser light on an outer side of the range of the constant distance from the center of the effective diameter.

5. The optical pickup device according to claim 4, wherein the phase correcting element includes:
a first electrode;
a second electrode arranged facing the first electrode;
a first orientation film arranged on a surface facing the second electrode of the first electrode;
a second orientation film arranged on a surface facing the first electrode of the second electrode; and
a liquid crystal layer filled between the first orientation film and the second orientation film; wherein
the first electrode has an electrode pattern for providing the spherical aberration correcting effect to the laser light within the constant distance from the center of the effective diameter, and for providing the optical effect other than the correcting effect for the spherical aberration to the laser light on the outer side of the range of the constant distance from the center of the effective diameter.

6. The optical pickup device according to claim 4 or 5, wherein the phase correcting element provides an astigmatism correcting effect to the laser light on the outer side of the range of the constant distance from the center of the effective diameter.
